(19) United States
(12) Patent Application Publication
(10) Pub. No.: US 2025/0055537 A1
(43) Pub. Date: Feb. 13, 2025

(54) NW-first Separate Sequential Training With Raw Dataset Sharing Scheme For AIML-enabled CSI Compression

(71) Applicant: Nokia Technologies Oy, Espoo (FI)

(72) Inventors: Jee Hyun KIM, Unterhaching (DE); Aakash SAINI, München (DE); Amir Mehdi AHMADIAN TEHRANI, Munich (DE); Filippo TOSATO, Villebon sur Yvette (FR)

(21) Appl. No.: 18/795,500

(22) Filed: Aug. 6, 2024

Related U.S. Application Data
(60) Provisional application No. 63/531,057, filed on Aug. 7, 2023.

(51) Int. Cl. H04B 7/06; H04L 25/02; H04W 8/22; H04W 24/02

(52) U.S. Cl. CPC H04B 7/0626; H04L 25/0248; H04W 8/22; H04W 24/02

(57) ABSTRACT

Embodiments provide for an apparatus, method and computer program product at least for training an artificial intelligence decoder using at least an input to a hypothetical artificial intelligence encoder; determining a training dataset comprising the input to the hypothetical artificial intelligence encoder and at least one of: unquantized projected channel state information feedback, or dequantized projected channel state information feedback; transmitting the training dataset to a user equipment; and determining reconstructed channel state information, using the trained artificial intelligence decoder.

### TECHNICAL FIELD

The examples and non-limiting example embodiments relate generally to communications and, more particularly, to a NW first separate sequential training with raw dataset sharing scheme for AIML-enabled CSI compression.

### BACKGROUND

It is known to measure channel state information for use in adapting transmissions in a communication network.

### BRIEF DESCRIPTION OF THE DRAWINGS

The foregoing aspects and other features are explained in the following description, taken in connection with the accompanying drawings.

FIG. 1 is a high level block diagram of an AIML (autoencoder) supported CSI feedback scheme (\hat{V}: estimated channel eigenvector, which is a “target CSI” in the depicted example).

FIG. 2 shows a UE-first separate training operation.

FIG. 3 shows a NW-first separate training operation.

FIG. 4 shows NW-first separate training with NW-side decoder API sharing (“Freeze-and-Train”).

FIG. 5 is a flow chart view of the herein described NW-first separate training framework with raw dataset sharing (Q: quantizer, dQ: dequantizer).

FIG. 6 shows a NW-first separate training framework with raw (unquantized) dataset sharing.

FIG. 7 is a message sequence chart between the UE and gNB for an over-the-air training dataset sharing scenario.

FIG. 8 shows UE-side training operations, including AI encoder training and quantizer learning.

FIG. 9 shows a UE-side (common) AI encoder model update operation scenario.

FIG. 10 shows empirical distributions of (raw and quantized) latent vector elements with a TF-based encoder-decoder (uniform SQ with {1,2,3} bit(s) resolution per each element).

FIG. 11 shows inference results (SGCS) for various training proposals (the herein described scheme: “sepNwFirstwRawDS”-Separate NW-First training with Raw Dataset Sharing; x-axis: [52*1 64*1 104*1 52*2 64*2 64*3] where latent vector dimension*number of Q bit per element).

FIG. 12 shows inference results (SGCS) for various training proposals with linear y-axis.

FIG. 13 is a block diagram of one possible and non-limiting system in which the example embodiments may be practiced.

FIG. 14 is an example apparatus configured to implement the examples described herein.

FIG. 15 shows a representation of an example of non-volatile memory media used to store instructions that implement the examples described herein.

FIG. 16 is an example method, based on the examples described herein.

FIG. 17 is an example method, based on the examples described herein.

### DETAILED DESCRIPTION OF EXAMPLE EMBODIMENTS

### 3GPP Release 18 Study Item AIML for Air Interface Enhancements

One of the study items of 3GPP Rel18 is AIML for CSI feedback enhancements. This activity investigates a set up in which CSI feedback processing part at UE-side is replaced with an AI encoder (possibly followed by a quantizer), and its output is used as the CSI feedback information to be signaled to NW over the air. The format of this AI encoded CSI feedback does not necessarily follow the current 3GPP defined format, e.g., Type I, Type II, enhanced Type II codebook, etc.

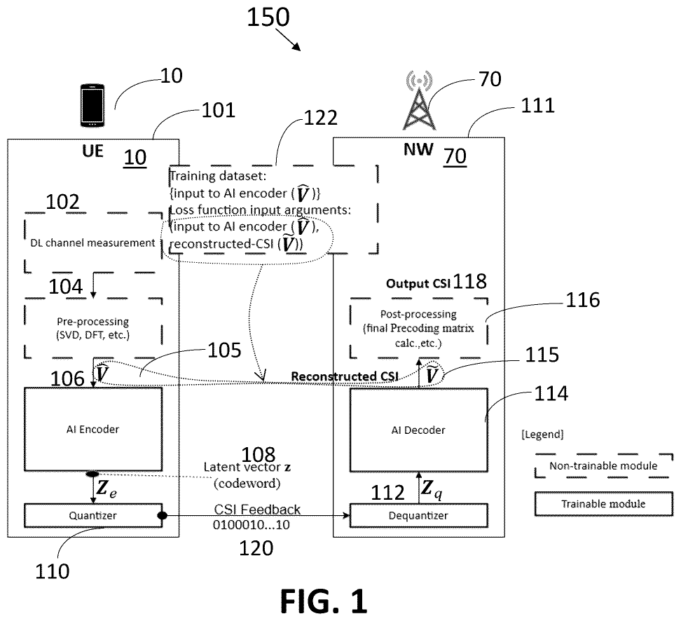

FIG. 1 is a high level block diagram of AIML (autoencoder) supported CSI feedback scheme (V: estimated channel eigenvector 105, which is a “target CSI” in the depicted example). Target CSI can be considered as the version of CSI that the NW-side 111 should retrieve if the CSI feedback mechanism is lossless.

General AIML (autoencoder)-enabled CSI feedback scheme is depicted in FIG. 1, in which Joint end-to-end (E2E) model training case is considered. At the UE side 101 (depicted is UE 10), downlink channel is estimated (102) using CSI-RS, and the required preprocessing is done (104) on the channel estimates, e.g., SVD to acquire channel eigenvector(s), etc. These channel eigenvectors (105), such as in [RANI #112] where the input CSI a precoding matrix is in the spatial-frequency domain, are being fed into AI encoder 106. The output of AI encoder, i.e., latent vector (108), is to be quantized (110) to reduce CSI (in this case AI-compressed PMI) feedback overhead. Note that other types of the channel information, e.g., full channel matrix, can be also used as an input to AI encoder 106 in addition to the channel eigenvectors 105. At NW side 111 (depicted is network node 70), which receives as input CSI feedback information 120 from the UE side 101, the reverse operations, i.e., dequantization (112), AI decoding (114), is done to reconstruct the original channel information, in this case the channel eigenvector(s). The reconstructed channel information 115 is further post-processed at 116 (e.g., re-orthogonalization procedure), if required, and its outcome is termed as “output CSI” 118 at 3GPP.

For typical autoencoder, AI encoder 106 and AI decoder 114 are trained at the same training session by the same training entity to come up with the best possible parameters at the AI encoder 106 and AI decoder 114 ([RANI #110] “Type 1: Joint training with single training entity”). Note in this case the training entity can take input to AI encoder (e.g., AI encoder input (channel eigenvectors 105) at UE-side 101) and reconstructed CSI 115 (AI decoder output at NW-side 111) as arguments of the loss function during training as depicted in FIG. 1 (refer to 122). However, this enforces disclosure of the proprietary AI encoder 106 or AI decoder 114 details (AIML framework, architecture, layer configuration, etc.), so it is not so likely that UE and NW vendors would agree on this training option (Type 1). In this sense, “Type 3: Separate training” has been gaining support from numerous UE and NW vendors at 3GPP, as UE vendor and NW vendor do not need to reveal their proprietary AI encoder/decoder related information to other parties. The third option (Type 2: joint training with two training entities) consists in training both encoder and decoder in the same training session but with two separate training entities that exchange gradients during training.

Separate training can be categorized into two flavors, i.e., UE-first training and NW-first training.

output-CSI-UE, input-CSI-NW

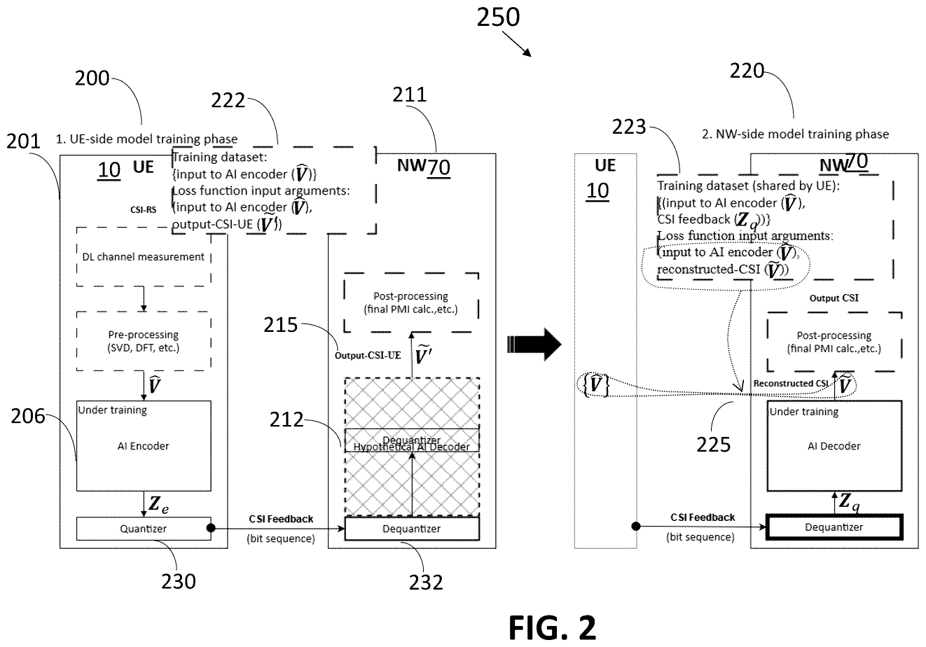

Separate training case does not mandate that UE vendors and NW vendors should share the AIML model details. In case of UE-first training, in which the AI encoder 206 at the UE side 201 is trained first, UE vendor needs to assume an AI decoder model at the NW side 211 when its UE side AI encoder 206 is being trained together with the corresponding hypothetical AI decoder 212 (phase 1 200 in FIG. 2). At this UE-side model training phase (phase 1 200), the output at the hypothetical AI decoder 212 of NW side 211 (which is assumed at UE side 201) is termed as “output-CSI-UE” 215 in 3GPP. Also shown in FIG. 2 is the NW-side model training phase 220.

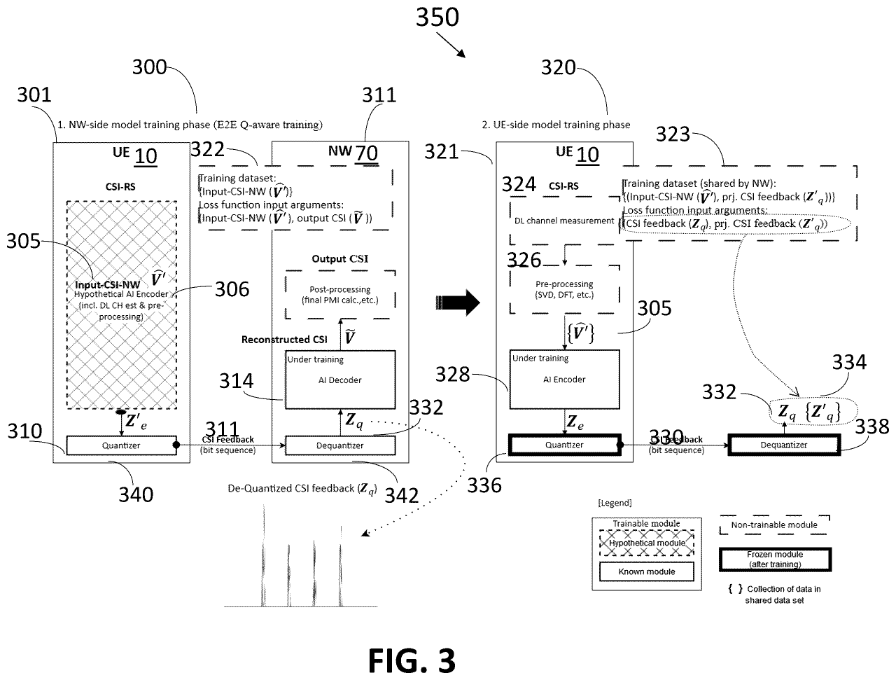

In case of NW-first training, in which the AI decoder 314 at the NW side 311 is trained first, NW vendor needs to assume an AI encoder model 306 at the UE side 301 when its NW side AI decoder 314 is being trained together with the corresponding hypothetical AI encoder 306 (phase 1 300 in FIG. 3). At this NW-side model training phase (phase 1 300), the input at the hypothetical AI encoder 306 of UE side (which is assumed at NW side 311) is termed as “input-CSI-NW” 305 in 3GPP. Note that hypothetical quantizer 310 is also assumed by NW-side 311, together with hypothetical AI encoder model 306. Also shown in FIG. 3 is the UE side model training phase 320.

In CSI compression using the two-sided model use case, separate AI/ML model training at the network and UE side (termed Type 3 AI/ML model training) may be beneficial, where the UE-side CSI generation part and the network-side CSI reconstruction part are trained by UE side and network side, respectively. Separate training may include sequential training starting with UE side training, or sequential training starting with NW side training. Evaluation of quantization aware or non-aware training may be based on quantization aware training, where quantization or dequantization is involved in the training process. CSI compression using the two-sided model use case when the reconstructed output CSI assumed at UE, or the “input-CSI-NW”305 (the input CSI assumed at the UE-side hypothetical AI encoder, by the NW), is a precoding matrix, where in one option the precoding matrix is in the spatial-frequency domain, and in another option the precoding matrix is in the angular-delay domain.

### Major Trends and Key Takeaways

Based on readings of 3GPP Rel18 agreements and submitted TDOCs, the following trend and possible convergence points can be observed. As regards model training strategy for two-sided model use case, Type 3 Separate training has gained supports from many manufacturers, UE vendors and NW vendors alike. Type 3 Separate training allows NW-side or UE-side stand alone training, based on the training data set (222, 223, 322, 323) sharing with other party, without having to disclose its own model details, e.g., AIML backbone architecture, model details, etc. Type 3 Separate training can be categorized into two groups in large, i.e., UE-first sequential training, and NW-first sequential training. In case of the UE-first separate training (depicted in FIG. 2), NW vendors need to handle multiple UE-side (encoder) models, whereas UE vendors can focus on single (or only a few) encoder model(s). In case of the NW-first separate training (depicted in FIG. 3), UE vendors need to handle multiple NW-side (decoder) models, whereas NW vendors can focus on single (or only a few) decoder model(s). Due to the above reason, a NW-vendor is likely to prefer the NW-first separate training, due to this relating to the case in which gNB 70 maintains only a small number of models. UE-vendors may be inclined to adopt a NW-first training “Freeze-and-Train” scheme. Another major benefit of the NW-first training scheme is that it does not incur large engineering costs of the decoder model update when UE side encoder model change/update takes place. In short, UE model training and update can happen without involving NW-side training.

The procedure of the NW-first separate sequential training is illustrated in FIG. 3. The whole procedure can be categorized into two main phases, i.e., the NW-side model training phase 300 and the UE-side model training phase 320.

1. NW-side model training phase (300). NW 70 performs training on its NW-side AI decoder model 314. As depicted in FIG. 3, NW-side 311 should come up with a hypothetical UE-side model 306 for generation of UE-side projected outcome, i.e., projected CSI feedback 311. As a result of NW-side training, a training dataset 322 of {hypothetical input to AI encoder (input-CSI-NW: \hat{V}′)} 305 can be used for its self-supervised learning. Note here that NW-side 311 should have a UE-side hypothetical models of DL channel measurement and subsequent pre-processing (e.g. hypothetical models of DL channel measurement 324 and pre-processing 326), as well as AI encoder 306. An input to AIML model at UE-side is an outcome which has gone through the UE-specific signal processing chain prior to AIML model, i.e., RF chain, channel estimation 324, pre-processing 326 like SVD, etc. This pre-AIML signal processing operations are highly UE/modem-vendor proprietary, and if the details are not to be shared, NW vendors need to come up with hypothetical model, which is marked by [′] (prime) in this disclosure. Note that sometimes [′] (prime) has been omitted for clarity when its distinction is not critical. Or alternatively, UE-vendors can provide a pre-processed channel information which considers UE-vendor specific operations or impacts like channel estimation, SVD, and RF nonlinearity, etc. On completion of NW-side model training 300 (with its own assumption of the hypothetical UE-side model 306), NW can provide UE-side with the resulting training dataset 323, e.g., {(hypothetical input to AI encoder (input-CSI-NW: \hat{V}′) 305, projected CSI feedback (z_{q}′))} 311, for the subsequent UE-side model training 320.

2. UE-side model training phase (320). UE-side 321 can start the training of its AI encoder 328 based on the NW-provided training dataset 323, e.g., {(hypothetical input to AI encoder (input-CSI-NW: \hat{V}′) 305, projected CSI feedback (z_{q}′)) 311}. Note that NW-provided hypothetical input to AI encoder (input-CSI-NW 305) is output of the preceding hypothetical UE-side operation, i.e., DL channel measurement and pre-processing, which can be different from the actual UE-side operation (324, 326) (that is UE 10 proprietary) in use, unless it is directly provided by the specific UE-vendor. For UE-side model training 320, the appropriate loss function needs to be defined. One option is to take CSI feedback 330 (outcome of the actual UE-side model with quantization impact being considered: z_{q} 332) and projected CSI feedback 311 (outcome of the trained hypothetical UE-side model per NW vendor's hypothesis at the time of NW-side model training with quantization impact being considered: z_{q}′ 334). Note again that quantizer 336 at UE-side 321 and dequantizer 338 at NW-side should be aligned to remove ambiguity in interpreting CSI feedback bit sequence, to facilitate correct retrieval of z_{q} 332.

Note here that as depicted in FIG. 3 (see southwest part), the quantized CSI feedback 311 can be of coarse granularity, e.g., only 4 different levels per each latent vector element in case SQ is used with 2 bits/element allocation for the depicted example. When the loss function takes the quantized CSI feedback 311 as its input argument, this can degrade the model training performance at the UE side model training procedure 320, especially with low quantization resolution case.

UE-first separate sequential training (FIG. 2) does not suffer from this issue, as the training loss computed while training the NW-side model is based on the reconstructed CSI which has much finer granularity 225. Refer to FIG. 2 for better understanding.

It has been assumed that quantization and dequantization (Q-dQ) operation (230, 232, 340, 342) can be subject to training as well. Q-dQ operation itself can be learned during model training procedure of the 1^{st} training session, i.e., NW-side decoder training 300 in case of NW-first training, UE-side 201 encoder training in case of UE-first training. After the 1^{st} phase of the training session, Q-dQ operation and its related generated codebooks, if any, are fixed. At the subsequent operation, i.e., the 2^{nd} phase of the training session, quantizer itself is frozen, but model is being trained with Q-dQ in place. Hence all the cases explained with respect to the discussion of FIG. 2 and FIG. 3 can be considered as Quantization-aware training.

Unlike the UE-first separate sequential training at which the training loss computed while training the NW-side model is based on the output (or reconstructed) CSI 225 which has much finer granularity, the model training performance can degrade in case of the NW-first separate sequential training. For example, a ˜0.4 dB loss has been reported in terms of SGCS in case of “Type3: gNB-first” training case, compared with “Type3: UE-first” training case or “Type1: Joint baseline with VQ” case. This performance gap may seem insignificant at first glance, this can be used as an argument against NW-first training scheme, as performance degradation can add up whenever allowing other possible sources of degradation, e.g., quantization resolution limitation, channel estimation error, channel temporal evolution, etc. It is always good to be prepared with “tool sets” for possible performance enhancement scheme, in case it is required or asked for.

Moreover, the level of performance degradation of NW-first separate training (350) compared to UE-first separate training (250) or Joint E2E training (150) can be up to ˜2 dB (>1.8 dB) in case with uniform SQ (scalar quantization) when a low resolution (1.2 dB in case of CR (Compression Ratio) 16, >1.8 dB in case of CR8, both with 1 bit SQ) SQ is adopted.

The main reason of performance gap between NW-first scheme 350 and UE-first scheme 250 is that the training loss computed while training (320) the UE-side model for the NW-first training use case 350 is based on the (quantized) CSI feedback (311, 330, 332) which is of the coarse granularity.

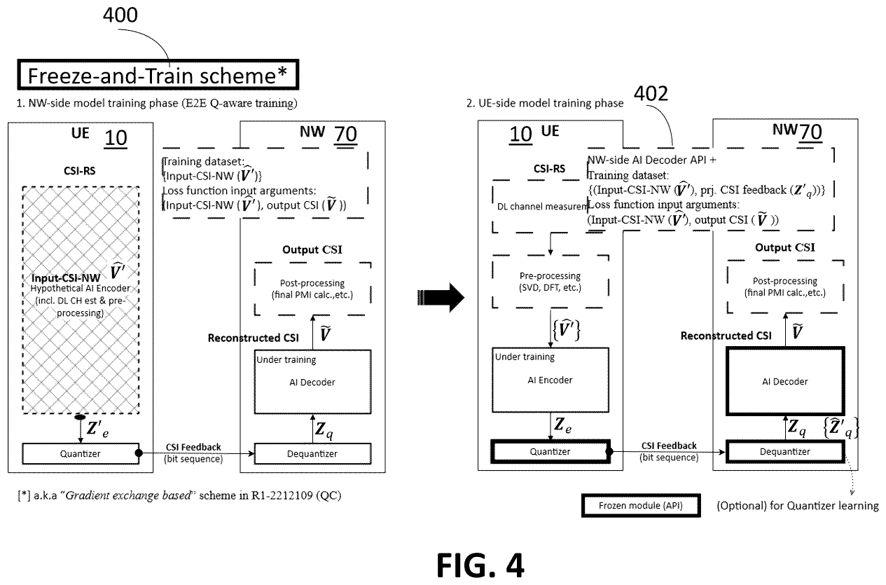

To address this issue, a “gradient-exchange based NW-first Type 2 training (a.k.a. “Freeze-and-Train”)” method (400) may be used, which has been shown to improve the encoder training performance by facilitating reconstructed CSI for UE-side encoder training session. However, this method may not be preferred, as it requires NW-vendors to provide an API 402 of the trained NW-side decoder model. Even though this does not mandate explicit disclosure of the NW-side decoder model details, there is still privacy concern from the NW-side, in the sense that reverse engineering practice may reveal sufficient information about the trained NW-side model, e.g., its capability, behavior on the various inputs, etc. Refer to FIG. 4 for better understanding of “Freeze-and-Train” scheme.

Described herein is a NW-first separate training scheme providing a decent performance with respect to competing schemes, e.g., UE-first separate training (250), NW-first training with “Freeze-and-Train” option (400), while not disclosing NW-vendor proprietary information.

Described herein is a model training framework for the NW-first separate sequential training use case which intends to address possible UE-side model training performance degradation caused by the coarse/low granularity of the input arguments of the loss function, without revealing NW-side decoder model information at the same time.

Also described herein are exemplary UE-gNB signaling essentials, i.e., possible messages and their contents, focusing on over-the-air training dataset sharing scenario.

The herein described scheme keeps the benefits of the separate training, which are: Two-sides, i.e., UE-side and NW-side, do not need to disclose its own model details, e.g., backbone architecture, model layer details, etc., and The individual party's model training can be done via sharing of the training data sets, which allows a separate training.

While keeping the benefit of the NW-first training scheme from NW-vendor perspective, which are (1-2):
1. NW-side is not required to maintain multiple models corresponding to each individual UE-models. Regarding NW-side decoder model at each vendor, single (or just a few) model(s) should be sufficient.
2. UE-side needs to cope with multiple NW-side models associated with various vendors, either by developing multiple dedicated UE models corresponding to each individual NW-side model, or by developing (the limited number of) common UE-side encoder model(s) which can generalize itself to multiple NW-side decoder models.

While it can improve the UE-side model as well as the overall E2E model training performance by: Enhancing granularity of the input arguments (i.e., CSI feedback) to the training loss function being used for UE-side training by the 1^{st} training entity (NW-side) providing raw (unquantized) CSI feedback (raw latent vector; zₑ) instead of its quantized version z_{q} as for usual conventional cases, after Quantization-aware NW-side decoder training. UE-side encoder training can be done on raw/unquantized CSI feedback as for the loss function argument, which is proven to improve the encoder performance up to ˜2 dB.

NW-side is supposed to provide {(hypothetical input to AI encoder (input-CSI-NW: \hat{V}′), (raw/unquantized) projected CSI feedback (zₑ′))} as UE-side training data set, after its own NW-side Quantization-aware training is completed.

This implies the quantized CSI feedback, e.g., distinctive pre-defined levels (for example 1, 2 or 3 bits information) per latent vector element or codeword index referring to the predefined codebook, is replaced with raw CSI feedback, e.g., high resolution (for example, 32 bit floating point) value per latent vector element.

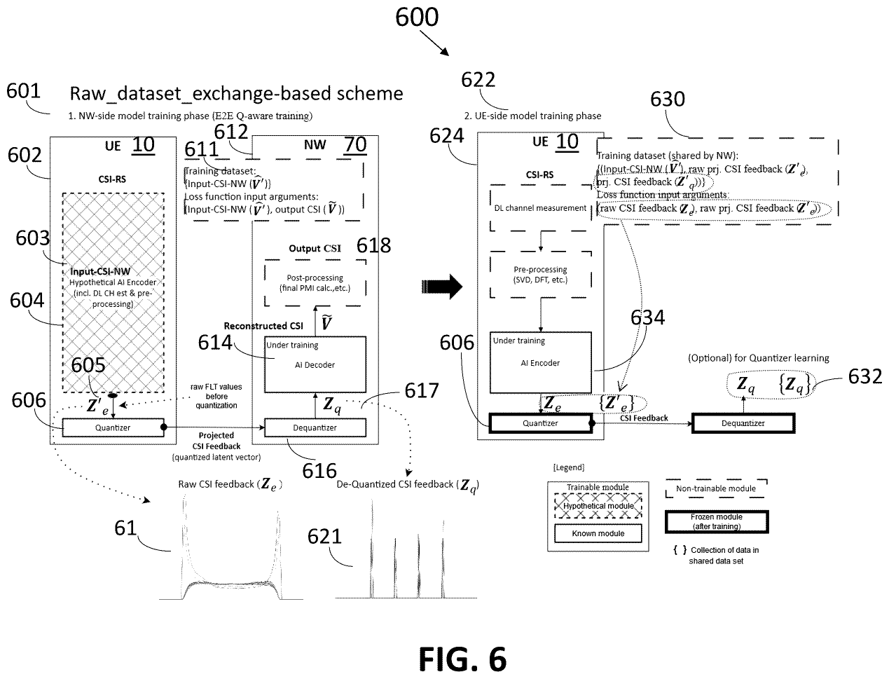

Note that as depicted in FIG. 6, quantizer-dequantizer operation is in place for NW-side decoder training phase, as well as in UE-side encoder training phase. Model parameters are being trained with quantization impact being considered.

NW-side has responsibility of the quantizer training, and NW-side model together with the associated quantizer-dequantizer operation is not tied with a specific UE-vendor's model or quantization scheme. Once Q-dQ operation is trained, its operation rule or associated codebooks are fixed and frozen at UE-side training procedure. The task of model generalization, if deemed beneficial, is on UE-side, meaning that UE-side may need to develop a common UE-side encoder model (including the associated quantizer) which can deal with possibly multiple NW-side decoder models, to avoid multiple one-to-one matching UE models.

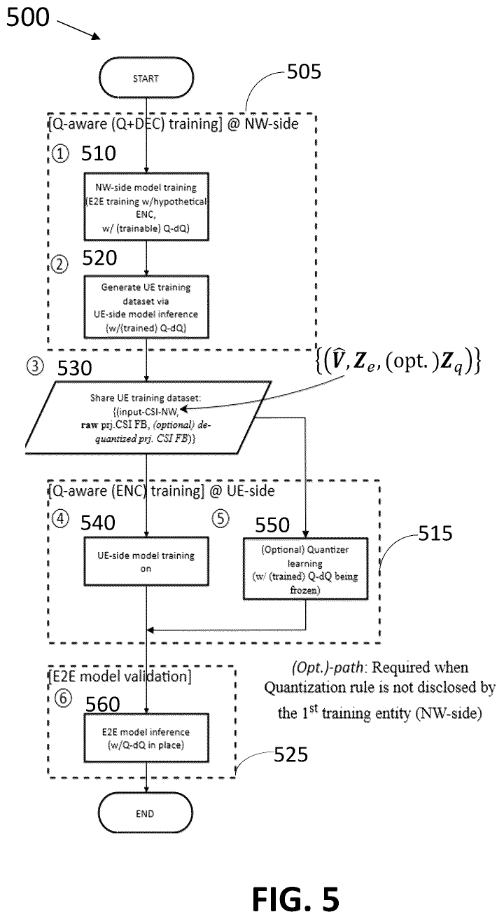

The overall procedure 500 can be found in a form of the flow chart in FIG. 5 with certain schemes being marked as the boxes 505 (comprising operations 510, 520), 515 (comprising operations 540, 550), and 525 (comprising operation 560).

The major advantages and technical effects of the herein described scheme are (1-4):
1. Simple though very effective. The overall conventional NW-first training operation can be kept intact. Up to ˜2 dB SGCS performance improvement observed with respect to the conventional case (see “Validation of the Method” part for details). Less than 0.1 dB gap with the upper reference case, i.e., Joint end-to-end case
2. At very low cost. No complexity increases at NW-side, No complexity increases at UE-side, Sole foreseeable cost: dataset size increase implies this should not matter in case of offline IODT-phase training, it can possibly matter in case of over-the-air dataset sharing use case.
3. Facilitating further possible improvements for UE-side training, Better quantization learning (if required), Better common encoder model training performance expected.
4. High level of detectability of third-party usage via inspection of the shared dataset.

The main use case of the examples described herein is offline vendor-to-vendor IODT-phase training. The underlining assumption on the major mode of operation for the herein described scheme is that this whole procedure can be done offline, for example at vendor-to-vendor IODT-phase. This may be preferred as well. This means that run-time gradient sharing is not required at all. Also, unlike the “Freeze-and-Train” scheme, NW-side does not need to provide UE-vendors with any NW-vendor's proprietary information related to its decoder model (no privacy concern for NW-vendors).

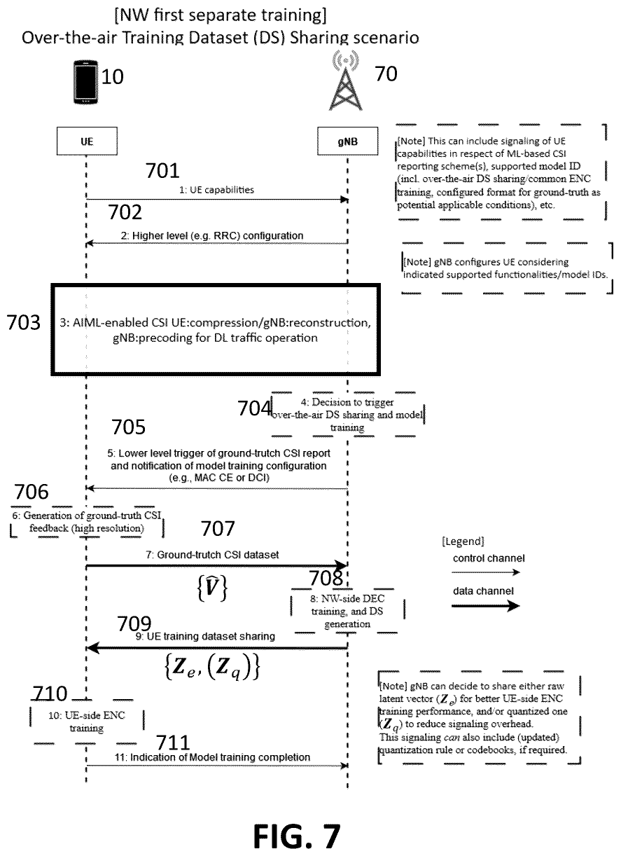

There can be another use case for the herein described scheme, i.e., over-the-air training dataset sharing scenario. With this use case in mind, a signaling operation between UE 10 and gNB 70 is illustrated in FIG. 7. The message and its possible contents can be standardized in upcoming 3GPP specification. Note that this procedure is designed to reduce over-the-air signaling overhead as well, based on observation of our numerical results.

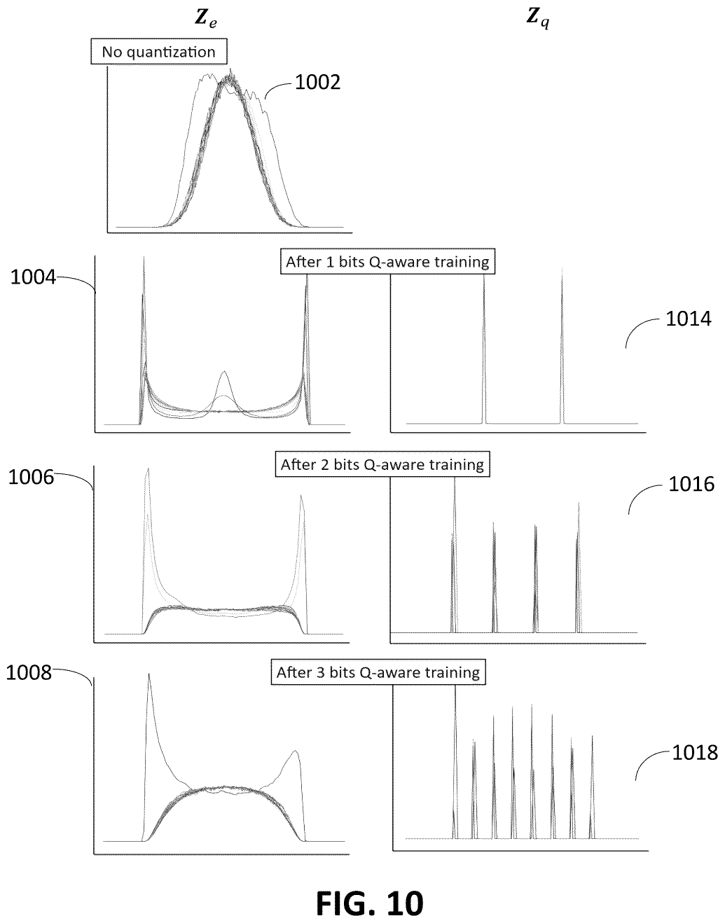

The herein described NW-first separate training framework is composed of two phases as for the conventional quantization-aware NW-first separate training, i.e., NW-side decoder together with quantizer-dequantizer training which is followed by training dataset generation, and UE-side encoder training based on the shared training dataset. The shared dataset is a set of tuples of (input-CSI-NW (channel eigenvector, for example), raw (unquantized) latent vector, quantized latent vector), i.e., {(\hat{V},zₑ,z_{q})} Here, the last term (quantized latent vector; z_{q}) can be optional, which does not need to be provided to UE-side when trained/finalized Q-dQ rule and/or resulting codebook and associated mapping scheme are shared by NW-side (the 1^{st} training entity). In case Q-dQ rule is not provided, dataset {(zₑ, z_{q})} can be used for Q-dQ learning. The point here is for NW-side (the 1st training entity) to share raw (unquantized) latent vector (zₑ) to improve encoder training at the UE-side by providing training data with rich and fine granularity (refer to FIG. 6 and FIG. 10 for empirical histograms of collected zₑ and z_{q}. Here, uniform SQ is used as a quantization scheme).

One possibly important use case scenario of the NW-first separate training is over-the-air training dataset sharing for over-the-air UE and gNB model training and update. As dataset sharing needs to be done via air interface in this case, it is critical to reduce signaling traffic over the air. Described herein is a general framework (exemplary signaling between UE and gNB) with possibility to reduce over-the-air traffic in mind. This has direct impact to 3GPP specification.

This section also includes a possible embodiment example of the UE-side training operation with focus on AI encoder training and Quantizer learning, and UE-side (common) AI encoder model update operation scenario as well.

Extensive model training and inference testing have been performed for validation of the herein described idea, and its results can be found in the latter part of this disclosure. The intermediate KPI, i.e., SGCS, is taken for the performance metric. The herein described scheme is on par with other competing alternatives, including upper reference case (Joint E2E training), UE-first training, and NW-first training with Freeze-and-Train option, with less than 0.1 dB performance gap. It has been shown that the herein described scheme can improve inference performance by up to ˜2 dB, compared to the conventional NW-first training approach. It confirms that the idea described herein can serve as the promising alternative scheme for NW-first separate sequential training case, without taking any risk of disclosing NW-side decoder model details.

NW-First Separate Training Framework with Raw Dataset Sharing

FIG. 5 (flowchart view) and FIG. 6 (system model block diagram) may be referred to for a better understanding of the concept description below.

1 (510). Do NW-side model training with the configurations below. (Phase 1 601 in FIG. 6).

Place (enable) both Quantizer 606 at UE-side 602, and a corresponding Dequantizer 616 at NW-side 612. The herein described method is transparent to the specific quantization scheme in use, i.e., SQ or VQ. Note that Q-dQ operation itself can be configured to be trained. SQ: uniform (with pre-defined fixed levels per element) as well as non-uniform (quantization levels are subject to Q-dQ training). VQ: overall latent vector, say dimension of 64, can be grouped into multiple numbers of subvectors, each of which is of smaller manageable dimension, e.g., 2, 3 or 4. Q-dQ training produces dedicated codebooks as a result. Codebooks can be generated with various levels of generality, e.g., per subvector dedicated, per layer dedicated (but subvector-common), or layer-common (presumably subvector-common).

E2E autoencoder (UE: (hypothetical) AI encoder 604, NW: AI decoder 614) training data set 611 is a set of Input-CSI-NW 603, which is an input to the hypothetical AIML encoder 604 at UE-side 602. It is either channel eigenvector or full channel matrix (or any other form of channel information), depending on the (3GPP or vendor-to-vendor) agreement. Note that in actual scenario, in order for UE 10 to acquire Input-CSI-NW 603, UE 10 needs to do channel parameter estimation based on CSI-RS (or other reference signals, if available), and to do pre-processing like SVD, etc. These are up to now UE-proprietary operations, and UE-side baseband received signals are subject to nonlinearity effect of RFIC. Due to this reason UE vendors may want to provide NW vendors with Input-CSI-NW 603 for AIML-enabled CSI compression use case as well, to better reflect UE-vendor chipset specifics.

Loss function for E2E autoencoder training is based on Output CSI 618 (reconstructed channel eigenvector, for example, at NW-side 612). The main subject of training is AI decoder 614 at NW-side 612 and Quantizer 606 and deQuantizer 616 operation (if configured) in this practice. Note that as quantization effects are considered during the training procedure, it is a Quantization-aware training.

2 (520). Once NW-side 612 model training is completed, UE-side training data set 630 needs to be generated on the trained NW-side decoder model 614 (together with the trained hypothetical UE-side encoder model 604 and the trained Q-dQ operation, if configured).

3 (530). NW-side 612 to provide UE-side 624 with a training data set for UE-side training 622. x′: [*] (prime symbol) is used to indicate a value from the hypothetical pre-AIML model 604, i.e., channel estimation, pre-processing like SVD, etc. at UE-side 602, which can be different from the actual model. [′] (prime symbol) is sometimes omitted in this disclosure for simplicity when its indicated value is obvious or does not play critical role in its interpretation. {(hypothetical input to AI encoder (input-CSI-NW: \hat{V}′) 603, (raw/unquantized) projected CSI feedback (zₑ′) 605, (optional) projected CSI feedback (z_{q}′) 632}. Raw projected CSI feedback (zₑ) 605 has much richer structure with fine granularity than its quantized version (z_{q}) 617. FIG. 6 shows the empirical histogram 613 of the raw/unquantized CSI feedback (latent vector) 605, and an empirical histogram 621 of the quantized CSI feedback 617. Dimension of the latent vector 605 is 64, and each latent vector element is depicted with different color (shown only selected indices for clarity). Scalar uniform quantizer with 2 bits/element (4 distinctive levels) is used for quantization scheme. If Q-dQ operation configuration details, meaning zₑ [symbol] z_{q} mapping rule and/or generated codebook set in case of VQ, are to be provided by the 1st training entity (NW-side 612 in case of NW-first training) to the 2^{nd} training entity (UE-side 624 in case of NW-first training 600), then sharing of z_{q} 617 is not required for UE-side training. If not, zₑ [symbol] z_{q} mapping rule needs to be also learned by UE side 624 (step 5 (550). In this case, {(zₑ, z_{q})} dataset can be used by UE-side 624 for Q-dQ learning.

4 (540). Do UE-side 624 model training with the configurations below. (Phase 2 (622) in FIG. 6). Place (enable) trained Quantizer 606 at UE-side 624. Note that Q-dQ operation in this stage is frozen, and not subject to change. Use the NW-side provided training data set 630, i.e., {(hypothetical input to AI encoder (input-CSI-NW: \hat{V}′) 603, (raw/unquantized) projected CSI feedback (zₑ′) 605, (optional) projected CSI feedback (z_{q}′) 632}. Training is to be done without NW-side decoder 614 nor its runtime image via API in place. Loss function for AI encoder 634 training is based on (raw/unquantized) CSI feedback 605, which is an output of AI encoder 604 at UE-side 602. The main subject of training is AI encoder 634 at UE-side 624 in this practice. AI encoder parameter update shall be done on zₑ domain, which has much richer and finer granularity than z_{q} domain. As quantization effects are still observed during the training procedure, it is a Quantization-aware training.

5 (550). (Optional) Do Quantizer learning and/or codebook generation (in case of VQ), based on {((raw/unquantized) projected CSI feedback (z) 605, projected CSI feedback (z_{q}′) 632)}. This can be done in a separate and independent manner with respect to the UE-side model training. Note that at this stage Q-dQ operation itself is fixed and frozen (no change allowed). Main objective of this step is for UE-side to learn trained Q-dQ operation, in case Q-dQ rule and/or associated codebook(s) are not shared.

6 (560). Perform E2E model (with Quantizer/Dequantizer in place) inference testing to evaluate the E2E model performance.

The above procedure should be repeated per every CR (Compression Ratio) and quantization bit resolution combination in use, to acquire trained parameter sets associated with each CR and bit resolution combination. As shown in FIG. 10, the underlining raw latent vector (zₑ) distribution is very close to Gaussian distribution (except for a few outliers) when quantization is bypassed (1002). However, “plugging-in” of Q-dQ operation (uniform SQ is adopted for the case which is depicted in FIG. 10) dramatically alters zₑ distribution, and it shows quite different shape per quantization resolution (number of bits per element in FIG. 10; refer to the “evolution” of zₑ distribution from top to bottom, as the quantization bit resolution increases, including after 1 bit Q-aware training 1004, after 2 bits Q-aware training 1006, and after 3 bits Q-aware training 1008).

### Over-the-Air Training Dataset Sharing Scenario: Potential 3GPP Standard Impact

The herein described scheme's major use case is NW-first training during IODT-phase. In this case, over-the-air dataset sharing is not required, as gNB equipment or its equivalent decoder model as well as UE equipment or its equivalent encoder model (incl. associated channel estimation, pre-processing schemes) can be provided with dataset that can be uploaded to or be downloaded from the designated server with a wired connection (sharing via air interface is not required). However, once these trained UE devices together with the trained NW equipments are up and running after IODT completion, there might be the cases in which over-the-air training dataset sharing is unavoidable due to necessity of re-training for model parameter updates.

Conceivable cases can be as follows, but not limited to: (1-2):
1. When UE-side model re-training is required due to: UE-side AI encoder model updates, e.g., change of AIML model architecture, model expansion (more/less number of layers, parameter resolution change, etc.), and/or UE-side non-AIML signal processing chain updates, e.g., different RF component (hence different non-linearity behavior), frontend signal processing algorithm update, baseband channel estimation and pre-processing (SVD) algorithm updates, etc.
2. When gNB would like to launch latest channel data collection for model updates to achieve: i) Update of gNB decoder as well as UE encoder (possibly Q-dQ operation as well), as gNB detects performance degradation of the previously trained models, ii) Development of cell-specific and/or time of day-specific trained models, to customize the gNB-UE models adaptively to the specific cell traffic scenario and/or specific time of day (at the middle of night, early morning, or busy daytime, etc.).

In over-the-air training dataset sharing scenario, it is important to reduce signaling overhead at the air interface. This section presents one example interaction between UE and gNB in terms of signaling and associated operations regarding this scenario. Refer to FIG. 7 for the corresponding illustration.

1 (701). As a part of UE capability reporting, UE 10 may report its supported training scheme, e.g., UE-first, NW-first, NW-first with raw dataset sharing, etc., to gNB 70, together with its capability for over-the-air dataset (DS) sharing feature, via during functionality-based or model ID-based LCM identification.

2 (702). The gNB, knowing UE's supported training scheme of over-the-air DS sharing for AIML-enabled CSI compression functionality in the context of NW-first separate training via UE's (capability) report, commands enabling of AIML-enabled CSI compression with over-the-air DS sharing feature support in use. From this point onwards, gNB and UE should be aware that over-the-air DS sharing can be triggered depending on AIML-enabled CSI performance monitoring outcomes at gNB side. There can be multiple format options for encoding of the ground-truth CSI, e.g., channel eigenvectors, and the format in use can be configured at this stage as well.

3 (703). AIML-enabled CSI operation is followed. gNB can apply performance monitoring as part of LCM in parallel, for example by monitoring BLER of PDSCH.

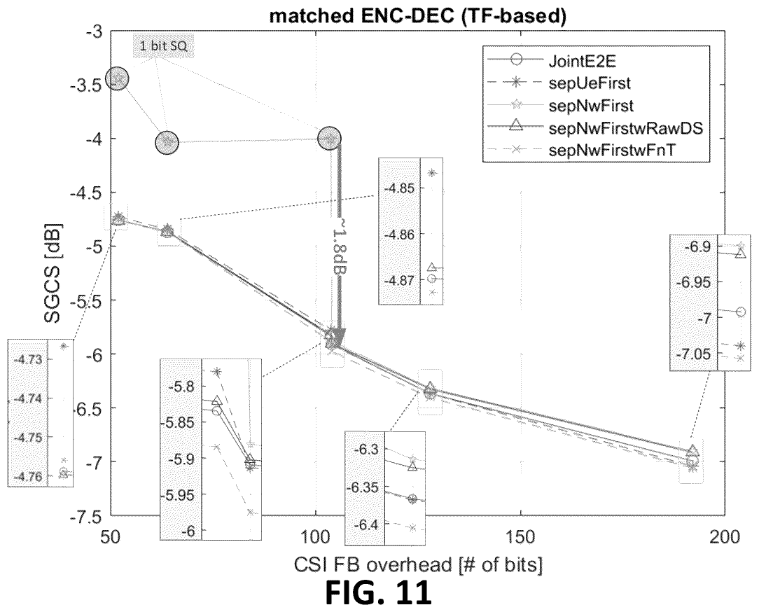

4 (704). Events, which are either defined in 3GPP or gNB vendor-proprietary, trigger gNB to initiate over-the-air DS sharing for model re-training and update. The gNB needs to determine CR and quantization bit resolution combination, and whether it should deliver raw (unquantized) latent vector (zₑ) or quantized latent vector (z_{q}), depending on the selected (CR, Q resolution) combination. For example, as depicted in FIG. 11, model inference performances are converged with certain combinations with high quantization resolution. In this case, sharing of the quantized latent vector should be sufficient while can save signaling overhead over-the-air. Otherwise, sharing of raw latent vector is required for the sake of better/acceptable training performance at the cost of air interface traffic.

5 (705). The gNB requests UE to measure downlink channel and report ground-truth CSI. Specific format for ground-truth CSI can be configured, if required. gNB may notify UE of configuration for upcoming model re-training, i.e., UE-first or NW-first training, necessity of Q-dQ learning, etc.

6 (706). The UE, upon gNB's request, measures DL channel, generate and report ground-truth CSI. As the UE is aware of upcoming model re-training procedure via gNB's signaling beforehand, it should keep CSI dataset (should save them in UE-internal memory).

7 (707). The UE sends ground-truth CSI dataset to the gNB. Due to its anticipated large size, data channel, i.e., PUSCH, can be used.

8 (708). The gNB performs NW-side decoder training, based on the received ground-truth CSI. Once training is completed, training dataset needs to be generated. To-be-shared training dataset for UE-side re-training should contain zₑ or z_{q} (depending on gNB's decision in step 4), or optionally zₑ together with z_{q}, in case gNB does not intend to provide the UE with (updated) Q-dQ rule, if any. In the latter case, the UE needs to learn Q-dQ rule and/or the associated codebook based on {(zₑ, z_{q})}.

9 (709). The gNB sends the UE training dataset for UE-side model re-training. In case gNB decides to share the updated Q-dQ rule as well, then signaling of the relevant information can be done at this stage.

10 (710). The UE, upon reception of training dataset of {zₑ, (z_{q})}, possibly together with updated Q-dQ rule, trigger UE-side AI encoder model training. Quantizer learning can be initiated as well, if required. Note here that the UE should still have access to the ground-truth CSI {\hat{V}} at this stage. Note also that the exact order of how {\hat{V}} is arranged should be exactly matching with that of the gNB-providing training dataset, i.e., {zₑ, (z_{q})}, for UE training exercise. At this stage, the UE can have the following possible combinations of the training dataset, i.e., {\hat{V},zₑ)}, {\hat{V},z_{q})} or {(\hat{V}, zₑ, z_{q})} More detailed description can be found in the subsequent subsection below.

{(\hat{V},zₑ)}: NW-first separate training with raw dataset sharing scheme; for UE-side AI encoder model re-training on zₑ domain

{(\hat{V},zₑ)}: Conventional NW-first separate training; for UE-side AI encoder model re-training on z_{q} domain.

{(\hat{V}, zₑ, z_{q})}: NW-first separate training with raw dataset sharing scheme; for UE-side AI encoder model re-training on zₑ domain, Q-dQ rule learning based on {(zₑ, z_{q})}.

11 (711). The UE, on completion of the UE-side model re-training (possibly with Q-dQ learning), can send the gNB an indication of the UE-side model training completion.

Note here that steps 4 (704) and 5 (705) can be altered to reflect UE-initiated case, meaning that the UE can request triggering of over-the-air DS sharing and model training, upon recognition of UE-side model update.

### UE-Side Training Operation Example: AI Encoder Training and Quantizer Learning

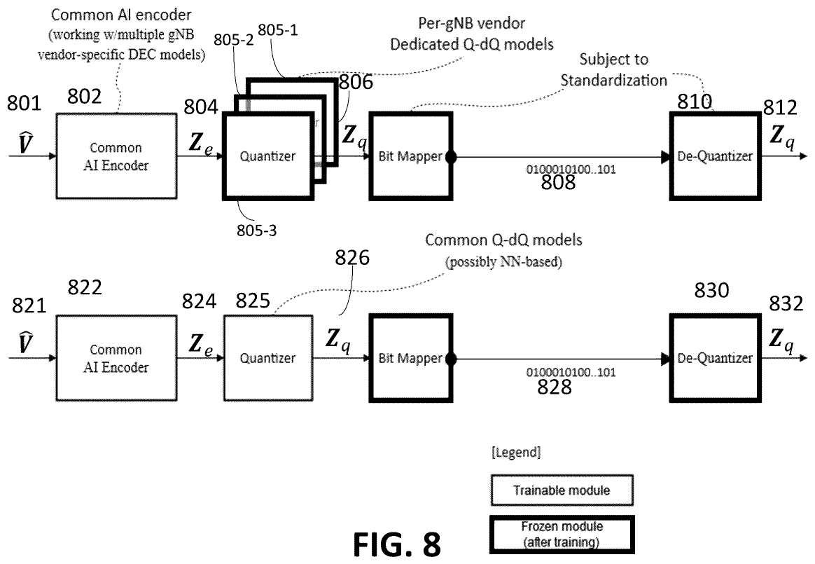

This subsection is dedicated to more detailed explanation of the UE-side training operation example (step 10 (710). of FIG. 7). Refer to FIG. 8 for accompanying illustration.

An assumption is that the UE 10 needs to support multiple gNB decoder models. Due to the limited computational power at UE, it is anticipated that UE vendor develops common AI encoder (802, 822) which can handle multiple gNB decoder models. Quantized latent vector (z_{q}) (806, 826) to bit sequence (808, 828) mapping and its reverse operation rule (810, 812, 830, 832) is shared between UE vendors and gNB vendors and can be subject to 3GPP standardization. Q-dQ (Quantizer-deQuantizer) operation rule: sharing of precise mapping from zₑ (804, 824) to z_{q} (806, 826), i.e., zₑ [symbol] z_{q}, and associated trained/generated codebook(s) can be subject to vendor-to-vendor alignment, and this information can be either shared between UE vendors and gNB vendors or kept proprietary to the 1^{st} training entity (gNB vendor in case of NW-first training scheme).

UE-side training scenario: common AI encoder (802, 822). When Q-dQ rule (and associated codebook in case of VQ) is provided by gNB vendors □ gNB vendor can provide only {zₑ} (804, 824) or {z_{q}} (806, 826), assuming UE vendor should have {\hat{V}} (801, 821) already. With per-gNB vendor specific quantizer(s) (805-1, 805-2, 805-3) [top figure]: dedicated per-gNB vendor specific quantizer(s) can be implemented at UE 10. The UE vendor can train common AI encoder 802, based on {(\hat{V},zₑ)} (801, 804) or {(\hat{V},z_{q})} (801, 806) which it has received from multiple gNB vendors. Q-dQ rule learning is not required. When Q-dQ rule (and associated codebook in case of VQ) is not provided by gNB vendors, this implies that the gNB vendor shall provide {(zₑ, z_{q})} (804, 806, 824, 826). With common Quantizer (possibly NN-based) [bottom figure]: UE vendor can develop and train common Quantizer 825, on top of common AI encoder 822, based on {(\hat{V}, zₑ, z_{q})} (821, 824, 826) of the multiple gNB-vendor sources. Alternatively (not shown in FIG. 8), the UE vendor can train to learn per-gNB vendor specific dedicated quantizers.

### UE-Side (Common) AI Encoder Model Update Operation Scenario

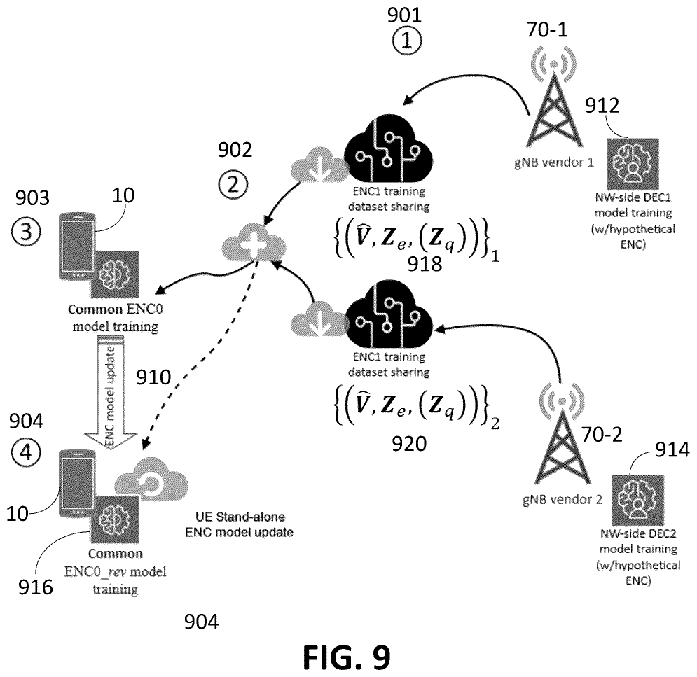

This subsection describes general operation scenario of the common AI encoder model training and update feature (FIG. 9). One of the major benefits of the NW-first separate training is that AI encoder model update 910 at UE-side (903 to 904) would not incur AI decoder (912, 914) re-training at gNB side at gNB 70-1 and gNB 70-2. As illustrated in 904 of FIG. 9, UE-side (common) AI encoder 916 can be re-trained on previously shared datasets, e.g., {(\hat{V},zₑ, (z_{q})}₁ 918 and {(\hat{V},zₑ, (z_{q})}₂ 920, in an isolated manner without involving gNB-side re-training. Hence it is not required for all the gNB-vendors to be involved to update gNB-side decoder models (912, 914) whenever the associated UE models 916 are being updated.

Note that for common AI encoder training use case, the herein described method can improve the common model training performance, by providing high granularity dataset of hypothetical AI encoder outputs {zₑ} associated with the individual gNB-vendor specific AI decoder models. The finer granularity (Refer to FIG. 10 for observation of the collected zₑ (left side) and z_{q} (right side), when uniform SQ is used as Q-dQ rule) of {zₑ}, the better AI encoder model training can differentiate signatures of each gNB-vendors, the more capable common AI encoder training becomes possible.

FIG. 10 shows the evolution of the z_{q} distribution from top to bottom, as the quantization bit resolution increases, including after 1 bit Q-aware training 1014, after 2 bits Q-aware training 1016, and after 3 bits Q-aware training 1018.

### Validation of the Method

The performance of the herein described method has been evaluated by means of model training and inference testing. Training dataset has been collected for 630,000 samples with configurations defined in Table 1. Data type of the ground-truth CSI is a normalized channel eigenvector (decomposed to real and imaginary parts), with a dimension of N_{sb}×2Nₜₓ, where N_{sb}: number of sub-bands (13) and Nₜₓ: number of TxAnt ports (32). Only the dominant channel eigenvector has been considered for training and inference testing for this exercise.
AIML backbone model: TF (5 layers); matched encoder-decoder
Training objective function: SGCS, MSE (when reconstructed CSI is not available at training phase)
Number of epochs used for model training: 200

Quantization: uniform SQ with predefined levels (quantization is not subject of training).

TABLE 1
SLS parameters for two-sided model training datasets

| Parameter | Value |
|---|---|
| Simulation scenario | UMa |
| Carrier frequency | 4 GHz (30 kHz SCS) |
| Bandwidth | 20 MHz |
| Num. cell sites, | 7 sites, 3 sectors per site |
| sectors per site | |
| BS antenna height | 25 m |
| Distribution of UEs | (80, 20) |
| (indoor %, outdoor %) | |
| UE speed (Indoor/Outdoor) | 3 km/h/30 km/h |
| Macrocell inter-site | 200 m |
| distance | |
| BS antenna array | (8, 8, 2, 1, 1, 2, 8) (32 ports), |
| | (dH, dV) = (0.5λ, 0.8λ) |
| UE antenna array | (1, 2, 2, 1, 1, 1, 2) (4 ports), |
| | dH = 0.5λ |

Evaluated two-sided model training schemes for comparison are (1-5):
1. Joint End-to-End (“JointE2E”): Type 1 training (see FIG. 1); upper reference case
2. UE-first separate training (“sepUeFirst”): Type 3 UE-first training (see FIG. 2)
3. NW-first separate training (“sepNwFirst”): Type 3 NW-first training; conventional one with z_{g} sharing (see FIG. 3).
4. NW-first separate training with raw dataset sharing (“sepNwFirstwRawDS”): the herein described scheme; Type 3 NW-first training with zₑ sharing (see FIG. 6).
5. NW-first separate training with Freeze-and-Train (“sepNwFirstwFnT”); Type 2 NW-first; a.k.a. Gradient-exchange based (see FIG. 4)

Selected (CR [latent vector dimension], bit allocation per element) combinations are (16[52], 1), (16[52], 2), (13[64], 1), (13[64], 2), (13[64], 3), (8[104], 1).

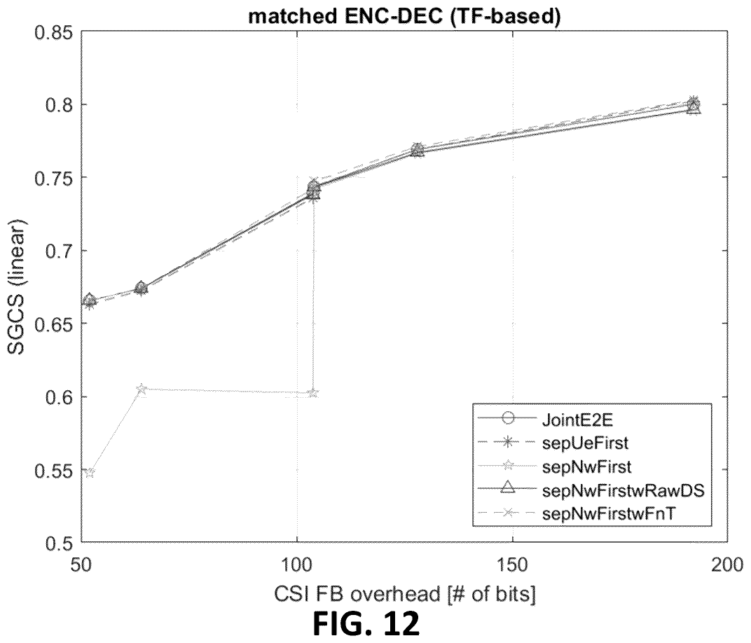

Inference results in terms of SGCS can be found in FIG. 11 (y-axis in dB) and FIG. 12 (y-axis in linear). Collected outcomes have been sorted in the increasing order of the overall CSI feedback overhead in bits, i.e., [52*1 64*1 104*1 52*2 64*2 64*3] where N_{dim}*n_{q} in which N_{dim}: latent vector dimension n_{q}: number of quantization bits per latent vector element. (104*1) case has been shifted forward by 0.2 for better visibility with respect to (52*2) case.

Observations. The higher CSI feedback overhead bits, the lower SGCS in dB, as expected. Difference between various two-sided model training options is small (less than 0.1 dB), as long as Quantization bit allocation per element is more than 1 bit. Conventional NW-first separate training shows clear performance degradation (from ˜1 dB up to ˜2 dB) compared to other cases including the herein described scheme, when quantization resolution is coarse (1 bit/element for the simulation cases). The herein described scheme (NW-first separate training with raw (unquantized) dataset sharing) brings about up to ˜2 dB performance enhancement compared to the conventional legacy scheme, whereas is on par with other methods including the upper bound reference case (Joint E2E), UE-first training, and the method shown in FIG. 4 which has high risk of revealing NW-side decoder model details (Freeze-and-Train).

The method described herein has adopted the uniform SQ and matched encoder-decoder case for numerical analysis. Mismatched encoder-decoder case and/or with VQ in place, i.e., codebook-based quantization, can provide another aspect of the herein described method's performance behavior compared with other competing schemes. In any case, it is anticipated that the herein described method would show superior performance with respect to the conventional NW-first separate training scheme.

The herein described scheme, i.e., NW-first separate training with raw dataset sharing, can serve as a very promising and competent candidate scheme of the NW-first separate training options which for a NW vendor may be preferable over other options like UE-first training or NW-first training with Freeze-and-Train.

Experiment results also indicate that depending on the operating region (in terms of overall CSI feedback overhead and/or quantization resolution) the training strategy can be formulated—at a certain region (usually low overhead case), conventional NW-first separate training cannot be a viable option at all due to its inferior performance. In this region, the herein described method can be a good alternative. Sharing of raw latent vector does not pose any challenge for offline IODT-phase training use case but can be burdensome for over-the-air training dataset sharing use case. In case of the over-the-air DS sharing use case, it may be beneficial to switch to the lower CR with higher bit resolution case of which the overall CSI feedback overhead is equivalent (e.g., CR8 with 1 bit/element implies CR16 with 2 bits/element). Sharing of quantized latent vector can save amounts of over-the-air traffic while guaranteeing the model training/inference performance.

FIG. 10 shows empirical distributions of (raw and quantized) latent vector elements with a TF-based encoder-decoder (uniform SQ with {1,2,3} bit(s) resolution per each element).

FIG. 11 shows inference results (SGCS) for various training proposals (the herein described scheme: “sepNwFirstwRawDS”-Separate NW-First training with Raw Dataset Sharing; x-axis: [52*1 64*1 104*1 52*2 64*2 64*3] where latent vector dimension*number of Q bit per element).

FIG. 12 shows inference results (SGCS) for various training proposals with linear y-axis.

The method described herein may be related to Rel-18 and can be used both by the UE-side and the NW-side for the NW-first separate training case of AIML supported CSI enhancement feature.

The method described herein may be specified in the 3GPP Specification (expected: TS38.214) as a part of procedure for CSI handling. There is the possibility that this level of training collaboration details is left for vendor-to-vendor alignment, and a NW vendor may implement the herein described scheme for the NW-first training scenario at IODT. In this case, counterpart UE vendors may correspondingly adapt their solution. The herein described scheme requires sharing of the training data set. As evidently shown in FIG. 10, distribution of zₑ and z_{g} is distinctively different.

The herein described UE-gNB signaling operation for over-the-air training dataset sharing as a whole or in part may be adopted by 3GPP (expected: TS38.214) as one of the anticipated use cases.

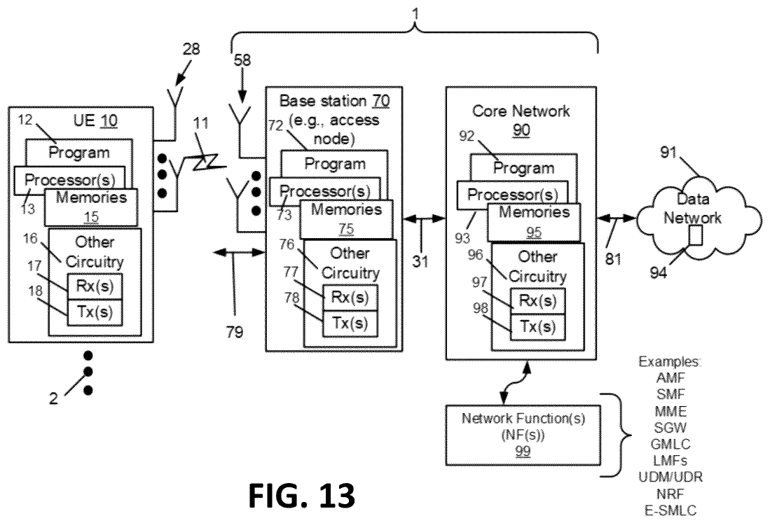

FIG. 13 shows a block diagram of one possible and non-limiting example of a cellular network 1 that is connected to a user equipment (UE) 10. A number of network elements are shown in the cellular network of FIG. 13: a base station 70; and a core network 90.

In FIG. 13, a user equipment (UE) 10 is in wireless communication via radio link 11 with the base station 70 of the cellular network 1. A UE 10 is a wireless communication device, such as a mobile device, that is configured to access a cellular network. The UE 10 is illustrated with one or more antennas 28. The ellipses 2 indicate there could be multiple UEs 10 in wireless communication via radio links with the base station 70. The UE 10 includes one or more processors 13, one or more memories 15, and other circuitry 16. The other circuitry 16 includes one or more receivers (Rx(s)) 17 and one or more transmitters (Tx(s)) 18. A program 12 is used to cause the UE 10 to perform the operations described herein. For a UE 10, the other circuitry 16 could include circuitry such as for user interface elements (not shown) like a display.

The base station 70, as a network element of the cellular network 1, provides the UE 10 access to cellular network 1 and to the data network 91 via the core network 90 (e.g., via a user plane function (UPF) of the core network 90). The base station 70 is illustrated as having one or more antennas 58. In general, the base station 70 is referred to as RAN node 70 herein. An example of a RAN node 70 is a gNB. There are, however, many other examples of RAN nodes including an eNB (LTE base station) or transmission reception point (TRP). The base station 70 includes one or more processors 73, one or more memories 75, and other circuitry 76. The other circuitry 76 includes one or more receivers (Rx(s)) 77 and one or more transmitters (Tx(s)) 78. A program 72 is used to cause the base station 70 to perform the operations described herein.

It is noted that the base station 70 may instead be implemented via other wireless technologies, such as Wi-Fi (a wireless networking protocol that devices use to communicate without direct cable connections). In the case of Wi-Fi, the link 11 could be characterized as a wireless link.

Two or more base stations 70 communicate using, e.g., link(s) 79. The link(s) 79 may be wired or wireless or both and may implement, e.g., an Xn interface for fifth generation (5G), an X2 interface for LTE, or other suitable interface for other standards.

The cellular network 1 may include a core network 90, as a third illustrated element or elements, that may include core network functionality, and which provide connectivity via a link or links 81 with a data network 91, such as a telephone network and/or a data communications network (e.g., the Internet). The core network 90 includes one or more processors 93, one or more memories 95, and other circuitry 96. The other circuitry 96 includes one or more receivers (Rx(s)) 97 and one or more transmitters (Tx(s)) 98. A program 92 is used to cause the core network 90 to perform the operations described herein.

The core network 90 could be a 5GC (5G core network). The core network 90 can implement or comprise multiple network functions (NF(s)) 99, and the program 92 may comprise one or more of the NFs 99. A 5G core network may use hardware such as memory and processors and a virtualization layer. It could be a single standalone computing system, a distributed computing system, or a cloud computing system. The NFs 99, as network elements, of the core network could be containers or virtual machines running on the hardware of the computing system(s) making up the core network 90.

Core network functionality for 5G may include access and mobility management functionality that is provided by a network function 99 such as an access and mobility management function (AMF(s)), session management functionality that is provided by a network function such as a session management function (SMF). Core network functionality for access and mobility management in an LTE network may be provided by an MME (Mobility Management Entity) and/or SGW (Serving Gateway) functionality, which routes data to the data network. Many others are possible, as illustrated by the examples in FIG. 13: AMF; SMF; MME; SGW; gateway mobile location center (GMLC); location management functions (LMFs); unified data management (UDM); unified data repository (UDR); network repository function (NRF); and/or evolved serving mobile location center (E-SMLC). These are merely exemplary core network functionality that may be provided by the core network 90, and note that both 5G and LTE core network functionality might be provided by the core network 90. The radio access network (RAN) node 70 is coupled via a backhaul link 31 to the core network 90. The RAN node 70 and the core network 90 may include an NG interface for 5G, or an SI interface for LTE, or other suitable interface for other radio access technologies for communicating via the backhaul link 31.

In the data network 91, there is a computer-readable medium 94. The computer-readable medium 94 contains instructions that, when downloaded and installed into the memories 15, 75, or 95 of the corresponding UE 10, base station 70, and/or core network element(s) 90, and executed by processor(s) 13, 73, or 93, cause the respective device to perform corresponding actions described herein. The computer-readable medium 94 may be implemented in other forms, such as via a compact disc or memory stick.

The programs 12, 72, and 92 contain instructions stored by corresponding one or more memories 15, 75, or 95. These instructions, when executed by the corresponding one or more processors 13, 73, or 93, cause the corresponding apparatus 10, 70, or 90, to perform the operations described herein. The computer readable memories 15, 75, or 95 may be of any type suitable to the local technical environment and may be implemented using any suitable data storage technology, such as semiconductor-based memory devices, flash memory, firmware, magnetic memory devices and systems, optical memory devices and systems, fixed memory and removable memory. The computer readable memories 15, 75, and 95 may be means for performing storage functions. The processors 13, 73, and 93, may be of any type suitable to the local technical environment, and may include one or more of general-purpose computers, special purpose computers, microprocessors, digital signal processors (DSPs) and processors based on a multi-core processor architecture, as non-limiting examples. The processors 13, 73, and 93 may be means for causing their respective apparatus to perform functions, such as those described herein.

The receivers 17, 77, and 97, and the transmitters 18, 78, and 98 may implement wired or wireless interfaces. The receivers and transmitters may be grouped together as transceivers.

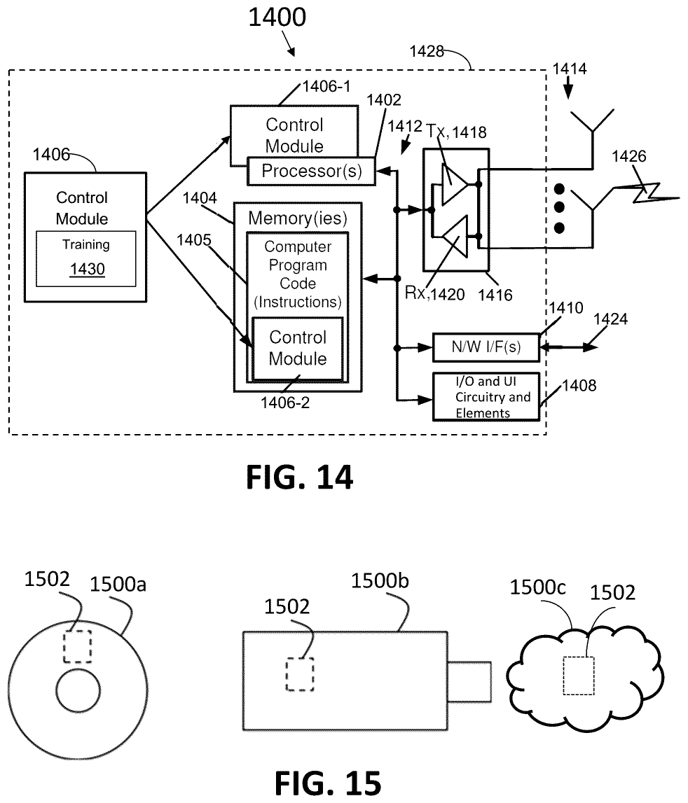

FIG. 14 is an example apparatus 1400, which may be implemented in hardware, configured to implement the examples described herein. The apparatus 1400 comprises at least one processor 1402 (e.g. an FPGA and/or CPU), one or more memories 1404 including computer program code 1405, the computer program code 1405 having instructions to carry out the methods described herein, wherein the at least one memory 1404 and the computer program code 1405 are configured to, with the at least one processor 1402, cause the apparatus 1400 to implement circuitry, a process, component, module, or function (implemented with control module 1406) to implement the examples described herein, including a NW first separate sequential training with raw dataset sharing scheme for AIML-enabled CSI compression. The memory 1404 may be a non-transitory memory, a transitory memory, a volatile memory (e.g. RAM), or a non-volatile memory (e.g. ROM). Training 1430 of the control module implements the herein described aspects related to a NW first separate sequential training with raw dataset sharing scheme for AIML-enabled CSI compression.

The apparatus 1400 includes a display and/or I/O interface 1408, which includes user interface (UI) circuitry and elements, that may be used to display aspects or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 1400 includes one or more communication e.g. network (N/W) interfaces (I/F(s)) 1410. The communication I/F(s) 1410 may be wired and/or wireless and communicate over the Internet/other network(s) via any communication technique including via one or more links 1424. The link(s) 1424 may be the link(s) 11 and/or 79 and/or 31 and/or 81 from FIG. 13. The link(s) 11 and/or 79 and/or 31 and/or 81 from FIG. 13 may also be implemented using transceiver(s) 1416 and corresponding wireless link(s) 1426. The communication I/F(s) 1410 may comprise one or more transmitters or one or more receivers.

The transceiver 1416 comprises one or more transmitters 1418 and one or more receivers 1420. The transceiver 1416 and/or communication I/F(s) 1410 may comprise standard well-known components such as an amplifier, filter, frequency-converter, (de) modulator, and encoder/decoder circuitries and one or more antennas, such as antennas 1414 used for communication over wireless link 1426.

The control module 1406 of the apparatus 1400 comprises one of or both parts 1406-1 and/or 1406-2, which may be implemented in a number of ways. The control module 1406 may be implemented in hardware as control module 1406-1, such as being implemented as part of the one or more processors 1402. The control module 1406-1 may be implemented also as an integrated circuit or through other hardware such as a programmable gate array. In another example, the control module 1406 may be implemented as control module 1406-2, which is implemented as computer program code (having corresponding instructions) 1405 and is executed by the one or more processors 1402. For instance, the one or more memories 1404 store instructions that, when executed by the one or more processors 1402, cause the apparatus 1400 to perform one or more of the operations as described herein. Furthermore, the one or more processors 1402, the one or more memories 1404, and example algorithms (e.g., as flowcharts and/or signaling diagrams), encoded as instructions, programs, or code, are means for causing performance of the operations described herein.

The apparatus 1400 to implement the functionality of control 1406 may be UE 10, base station 70 (e.g. gNB 70), or core network 90 including any of the network functions 99, which network functions 99 may be implemented with a network entity. Thus, processor 1402 may correspond to processor(s) 13, processor(s) 73 and/or processor(s) 93, memory 1404 may correspond to one or more memories 15, one or more memories 75 and/or one or more memories 95, computer program code 1405 may correspond to program 12, program 72, or program 92, communication I/F(s) 1410 and/or transceiver 1416 may correspond to other circuitry 16, other circuitry 76, or other circuitry 96, and antennas 1414 may correspond to antennas 28 or antennas 58.

Alternatively, apparatus 1400 and its elements may not correspond to either of UE 10, base station 70, or core network and their respective elements, as apparatus 1400 may be part of a self-organizing/optimizing network (SON) node or other node, such as a node in a cloud.

The apparatus 1400 may also be distributed throughout the network (e.g. 91) including within and between apparatus 1400 and any network element (such as core network 90 and/or the base station 70 and/or the UE 10).

Interface 1412 enables data communication and signaling between the various items of apparatus 1400, as shown in FIG. 14. For example, the interface 1412 may be one or more buses such as address, data, or control buses, and may include any interconnection mechanism, such as a series of lines on a motherboard or integrated circuit, fiber optics or other optical communication equipment, and the like. Computer program code (e.g. instructions) 1405, including control 1406 may comprise object-oriented software configured to pass data or messages between objects within computer program code 1405. The apparatus 1400 need not comprise each of the features mentioned, or may comprise other features as well. The various components of apparatus 1400 may at least partially reside in a common housing 1428, or a subset of the various components of apparatus 1400 may at least partially be located in different housings, which different housings may include housing 1428.

FIG. 15 shows a schematic representation of non-volatile memory media 1500a (e.g. computer/compact disc (CD) or digital versatile disc (DVD)) and 1500b (e.g. universal serial bus (USB) memory stick) and 1500c (e.g. cloud storage for downloading instructions and/or parameters 1502 or receiving emailed instructions and/or parameters 1502) storing instructions and/or parameters 1502 which when executed by a processor allows the processor to perform one or more of the steps of the methods described herein.

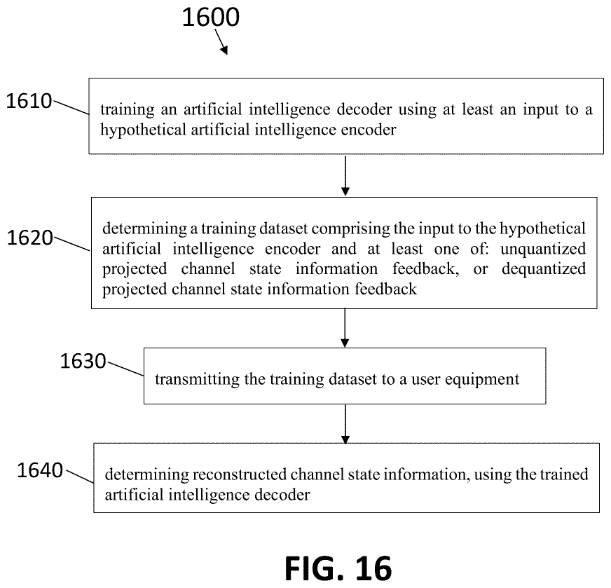

FIG. 16 is an example method 1600, based on the example embodiments described herein. At 1610, the method includes training an artificial intelligence decoder using at least an input to a hypothetical artificial intelligence encoder. At 1620, the method includes determining a training dataset comprising the input to the hypothetical artificial intelligence encoder and at least one of: unquantized projected channel state information feedback, or dequantized projected channel state information feedback. At 1630, the method includes transmitting the training dataset to a user equipment. At 1640, the method includes determining reconstructed channel state information, using the trained artificial intelligence decoder. Method 1600 may be performed by network node 70, a network entity of core network 90 (e.g. performed by a network function 99), or apparatus 1400.

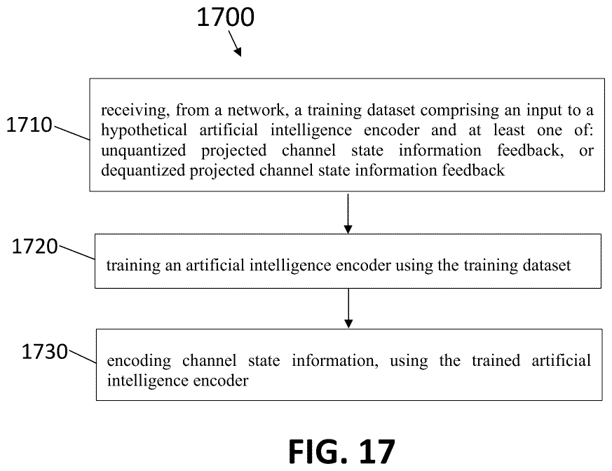

FIG. 17 is an example method 1700, based on the example embodiments described herein. At 1710, the method includes receiving, from a network, a training dataset comprising an input to a hypothetical artificial intelligence encoder and at least one of: unquantized projected channel state information feedback, or dequantized projected channel state information feedback. At 1720, the method includes training an artificial intelligence encoder using the training dataset. At 1730, the method includes encoding channel state information, using the trained artificial intelligence encoder. Method 1700 may be performed by user equipment 10 or apparatus 1400.

The following examples are provided and described herein.

Example 1. An apparatus including: at least one processor; and at least one memory storing instructions that, when executed by the at least one processor, cause the apparatus at least to: train an artificial intelligence decoder using at least an input to a hypothetical artificial intelligence encoder; determine a training dataset comprising the input to the hypothetical artificial intelligence encoder and at least one of: unquantized projected channel state information feedback, or dequantized projected channel state information feedback; transmit the training dataset to a user equipment; and determine reconstructed channel state information, using the trained artificial intelligence decoder.

Example 2. The apparatus of example 1, wherein the input to the hypothetical artificial intelligence encoder comprises at least one of: channel information, or a channel matrix, or a channel eigenvector, or a precoding matrix in a spatial-frequency domain.

Example 3. The apparatus of any of examples 1 to 2, wherein the unquantized projected channel state information feedback comprises a latent vector.

Example 4. The apparatus of any of examples 1 to 3, wherein the instructions, when executed by the at least one processor, cause the apparatus at least to: determine a quantization and dequantization rule; and transmit, to the user equipment, the quantization and dequantization rule.

Example 5. The apparatus of any of examples 1 to 4, wherein the instructions, when executed by the at least one processor, cause the apparatus at least to: transmit, to the user equipment, the dequantized projected channel state information feedback within the training dataset, when a quantization and dequantization rule is not transmitted to the user equipment, or when a codebook and mapping scheme is not transmitted to the user equipment.

Example 6. The apparatus of any of examples 1 to 5, wherein the unquantized projected channel state information feedback has finer granularity than the dequantized projected channel state information feedback.

Example 7. The apparatus of any of examples 1 to 6, wherein the instructions, when executed by the at least one processor, cause the apparatus at least to: train the artificial intelligence decoder using a loss function, wherein input arguments to the loss function comprise the input to a hypothetical artificial intelligence encoder and the reconstructed channel state information.

Example 8. The apparatus of any of examples 1 to 7, wherein the instructions, when executed by the at least one processor, cause the apparatus at least to receive, from a user equipment, at least one capability of the user equipment, wherein the at least one capability of the user equipment comprises at least one of: a supported model identifier, or a capability for over-the-air dataset sharing, or a capability for common encoder training, or a configured format for ground truth data sharing.

Example 9. The apparatus of any of examples 1 to 8, wherein the instructions, when executed by the at least one processor, cause the apparatus at least to: receive, from the user equipment, a ground truth input to an artificial intelligence encoder; train the artificial intelligence decoder using the ground truth input to the artificial intelligence encoder; and transmit, to the user equipment, the training dataset comprising at least one of the following: the unquantized projected channel state information feedback, or the dequantized projected channel state information feedback.

Example 10. The apparatus of example 9, wherein the instructions, when executed by the at least one processor, cause the apparatus at least to: transmit, to the user equipment, a trained quantization-dequantization rule together with the training dataset comprising the at least one of: the unquantized projected channel state information feedback, or the dequantized projected channel state information feedback.

Example 11. The apparatus of any of examples 1 to 10, wherein the instructions, when executed by the at least one processor, cause the apparatus at least to: receive, from the user equipment, an indication of completion of training of an artificial intelligence encoder using the training dataset.

Example 12. An apparatus including: at least one processor; and at least one memory storing instructions that, when executed by the at least one processor, cause the apparatus at least to: receive, from a network, a training dataset comprising an input to a hypothetical artificial intelligence encoder and at least one of: unquantized projected channel state information feedback, or dequantized projected channel state information feedback; train an artificial intelligence encoder using the training dataset; and encode channel state information, using the trained artificial intelligence encoder.

Example 13. The apparatus of example 12, wherein the input to the hypothetical artificial intelligence encoder comprises at least one of: channel information, or a channel matrix, or a channel eigenvector, or a precoding matrix in a spatial-frequency domain.

Example 14. The apparatus of any of examples 12 to 13, wherein the unquantized projected channel state information feedback comprises a latent vector.

Example 15. The apparatus of any of examples 12 to 14, wherein the instructions, when executed by the at least one processor, cause the apparatus at least to: receive, from the network, a quantization and dequantization rule; quantize the encoded channel state information and dequantize the quantized encoded channel state information, based on the quantization and dequantization rule.

Example 16. The apparatus of any of examples 12 to 15, wherein the instructions, when executed by the at least one processor, cause the apparatus at least to: receive, from the network, the dequantized projected channel state information feedback within the training dataset, when a quantization and dequantization rule is not received from the network, or when a codebook and mapping scheme is not received from the network; and learn a quantizer or generate a codebook, based on the unquantized projected channel state information feedback and the dequantized projected channel state information feedback; wherein the learning of the quantizer or the generating of the codebook is performed when the unquantized projected channel state information feedback and the dequantized projected channel state information feedback are in the same dataset or in different datasets.

Example 17. The apparatus of any of examples 12 to 16, wherein the unquantized projected channel state information feedback has finer granularity than the dequantized projected channel state information feedback.

Example 18. The apparatus of any of examples 12 to 17, wherein the instructions, when executed by the at least one processor, cause the apparatus at least to: train the artificial intelligence encoder using a loss function, wherein input arguments to the loss function comprise the unquantized projected channel state information feedback from the received training dataset and unquantized channel state information feedback taken at an output of the artificial intelligence encoder.

Example 19. The apparatus of any of examples 12 to 18, wherein the instructions, when executed by the at least one processor, cause the apparatus at least to transmit, to the network, at least one capability of the apparatus, wherein the at least one capability of the apparatus comprises at least one of: a supported model identifier, or a capability for over-the-air dataset sharing, or a capability for common encoder training, or a configured format for ground truth data sharing.

Example 20. The apparatus of any of examples 12 to 19, wherein the instructions, when executed by the at least one processor, cause the apparatus at least to: transmit, to the network, a ground truth input to the artificial intelligence encoder; and receive, from the network, the training dataset comprising at least one of the following: the unquantized projected channel state information feedback, or the dequantized projected channel state information feedback.

Example 21. The apparatus of example 20, wherein the instructions, when executed by the at least one processor, cause the apparatus at least to: receive, from the network, a trained quantization-dequantization rule together with the training dataset comprising the at least one of: the unquantized projected channel state information feedback, or the dequantized projected channel state information feedback.

Example 22. The apparatus of any of examples 12 to 21, wherein the instructions, when executed by the at least one processor, cause the apparatus at least to: transmit, to the network, an indication of completion of the training of the artificial intelligence encoder using the training dataset.

Example 23. A method including: training an artificial intelligence decoder using at least an input to a hypothetical artificial intelligence encoder; determining a training dataset comprising the input to the hypothetical artificial intelligence encoder and at least one of: unquantized projected channel state information feedback, or dequantized projected channel state information feedback; transmitting the training dataset to a user equipment; and determining reconstructed channel state information, using the trained artificial intelligence decoder.

Example 24. A method including: receiving, from a network, a training dataset comprising an input to a hypothetical artificial intelligence encoder and at least one of: unquantized projected channel state information feedback, or dequantized projected channel state information feedback; training an artificial intelligence encoder using the training dataset; and encoding channel state information, using the trained artificial intelligence encoder.

Example 25. An apparatus including: means for training an artificial intelligence decoder using at least an input to a hypothetical artificial intelligence encoder; means for determining a training dataset comprising the input to the hypothetical artificial intelligence encoder and at least one of: unquantized projected channel state information feedback, or dequantized projected channel state information feedback; means for transmitting the training dataset to a user equipment; and means for determining reconstructed channel state information, using the trained artificial intelligence decoder.

Example 26. An apparatus including: means for receiving, from a network, a training dataset comprising an input to a hypothetical artificial intelligence encoder and at least one of: unquantized projected channel state information feedback, or dequantized projected channel state information feedback; means for training an artificial intelligence encoder using the training dataset; and means for encoding channel state information, using the trained artificial intelligence encoder.

Example 27. A non-transitory program storage device readable by a machine, tangibly embodying a program of instructions executable by the machine for performing operations, the operations including: training an artificial intelligence decoder using at least an input to a hypothetical artificial intelligence encoder; determining a training dataset comprising the input to the hypothetical artificial intelligence encoder and at least one of: unquantized projected channel state information feedback, or dequantized projected channel state information feedback; transmitting the training dataset to a user equipment; and determining reconstructed channel state information, using the trained artificial intelligence decoder.

Example 28. A non-transitory program storage device readable by a machine, tangibly embodying a program of instructions executable by the machine for performing operations, the operations including: receiving, from a network, a training dataset comprising an input to a hypothetical artificial intelligence encoder and at least one of: unquantized projected channel state information feedback, or dequantized projected channel state information feedback; training an artificial intelligence encoder using the training dataset; and encoding channel state information, using the trained artificial intelligence encoder.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memories as described herein may be implemented using any suitable data storage technology, such as semiconductor based memory devices, flash memory, magnetic memory devices and systems, optical memory devices and systems, non-transitory memory, transitory memory, fixed memory and removable memory. The memories may comprise a database for storing data.

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memories that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

It should be understood that the foregoing description is only illustrative. Various alternatives and modifications may be devised by those skilled in the art. For example, features recited in the various dependent claims could be combined with each other in any suitable combination(s). In addition, features from different example embodiments described above could be selectively combined into a new example embodiment. Accordingly, this description is intended to embrace all such alternatives, modifications and variances which fall within the scope of the appended claims.

The following acronyms and abbreviations that may be found in the specification and/or the drawing figures are given as follows (the abbreviations and acronyms may be appended with each other or with other characters using e.g. a dash, hyphen, slash, or number, and may be case insensitive):

| | |
|---|---|
| 3GPP | third generation partnership project |
| 4G | fourth generation |
| 5G | fifth generation |
| 5GC | 5G core network |
| AI | artificial intelligence |
| AIML | artificial intelligence machine learning |
| AMF | access and mobility management function |
| Ant | antenna |
| API | application programming interface |
| ASIC | application-specific integrated circuit |
| BLER | block error rate |
| BS | base station |
| CD | compact/computer disc |
| CE | control element |
| CH | channel |
| CPU | central processing unit |
| CR | compression ratio |
| CSI | channel state information |
| CSI-RS | channel state information reference signal |
| DCI | downlink control information |
| DEC | decoder |
| DFT | discrete Fourier transform |
| dim | dimension |
| DL | downlink |
| DS | dataset |
| DSP | digital signal processor |
| dQ | dequantization |
| DVD | digital versatile disc |
| E2E | end to end |
| eNB | evolved Node B (e.g., an LTE base station) |
| ENC | encoder |
| EPC | evolved packet core |
| E-SMLC | evolved serving mobile location center |
| FB | feedback |
| FPGA | field-programmable gate array |
| GMLC | gateway mobile location center |
| gNB | next generation node B, base station for 5G/NR, |
| | i.e., a node providing NR user plane and control |
| | plane protocol terminations towards the UE, and |
| | connected via the NG interface to the 5GC |
| ID | identifier |
| I/F | interface |
| I/O | input/output |
| IODT | interoperability development testing |
| KPI | key performance indicator |
| LCM | lifecycle management |
| LMF | location management function |
| LTE | long term evolution (4G) |
| MAC | medium access control |
| MME | mobility management entity |
| MSE | mean squared error |
| NF | network function |
| NG | new generation |
| NG-RAN | new generation radio access network |
| NN | neural network |
| NR | new radio |
| NRF | network repository function |
| NW | network |
| N/W | network |
| opt. | optional |
| PDSCH | physical downlink shared channel |
| PMI | precoding matrix indicator |
| prj | projected |
| PUSCH | physical uplink shared channel |
| Q | quantization |
| Q-aware | quantization aware |
| Q-dQ | quantization and dequantization |
| RAM | random access memory |
| RAN | radio access network |
| RAN1 | radio layer 1 |
| RAN1# | RAN1 meeting |
| Rel | release |
| rev | revised |
| RF | radio frequency |
| RFIC | radio frequency integrated circuit |
| ROM | read-only memory |
| RRC | radio resource control |
| RS | reference signal |
| Rx | receiver or reception |
| S1 | interface connecting the eNB to the EPC |
| sb | sub-band or sub-bands |
| SCS | subcarrier spacing |
| sep | separate |
| sepNwFirstwFnT | NW-first separate training with Freeze-and-Train |
| sepNwFirstwRawDS | NW-first separate training with raw dataset |
| | sharing |
| SGCS | squared generalized cosine similarity |
| SGW | serving gateway |
| SLS | system level simulation |
| SMF | session management function |
| SON | self-organizing/optimizing network |
| SQ | scalar quantization |
| SVD | singular value decomposition |
| TDOC | technical document |
| TF | transformer |
| TRP | transmission reception point |
| TS | technical specification |
| Tx | transmitter or transmission |
| UDM | unified data management |
| UDR | unified data repository |
| UE | user equipment (e.g., a wireless, typically mobile |
| | device) |
| UI | user interface |
| UMA | urban macro |
| UPF | user plane function |
| USB | universal serial bus |
| VQ | vector quantization |
| Wi-Fi | wireless networking protocol that devices use to |
| | communicate without direct cable connections |
| X2 | network interface between RAN nodes and |
| | between RAN and the core network |
| Xn | network interface between NG-RAN nodes |

1.-28. (canceled)

29. An apparatus comprising:
at least one processor; and
at least one memory storing instructions that, when executed by the at least one processor, cause the apparatus at least to:
receive the following from a network: a training dataset comprising an input to a hypothetical artificial intelligence encoder, an unquantized projected channel state information feedback, and dequantized projected channel state information feedback, wherein the input to the hypothetical artificial intelligence encoder comprises: channel information, a channel matrix, a channel eigenvector, and a precoding matrix in a spatial-frequency domain, wherein the unquantized projected channel state information feedback comprises a latent vector, wherein the unquantized projected channel state information feedback has finer granularity than the dequantized projected channel state information feedback;
receive, from the network, the dequantized projected channel state information feedback within the training dataset, when a quantization and dequantization rule is not received from the network, or when a codebook and mapping scheme is not received from the network;
based on the unquantized projected channel state information feedback and the dequantized projected channel state information feedback, learn a quantizer and generate a codebook, wherein the learning of the quantizer and the generating of the codebook is performed when the unquantized projected channel state information feedback and the dequantized projected channel state information feedback are in a same dataset;
train an artificial intelligence encoder using a loss function, wherein input arguments to the loss function comprise the unquantized projected channel state information feedback from the received training dataset and unquantized channel state information feedback taken at an output of the artificial intelligence encoder; and
encode channel state information, using the trained artificial intelligence encoder.

30. The apparatus of claim 29, wherein the instructions, when executed by the at least one processor, cause the apparatus at least to transmit, to the network, capabilities of the apparatus, wherein the capabilities of the apparatus comprise: a supported model identifier, and a capability for over-the-air dataset sharing.

31. The apparatus of claim 30, wherein the capabilities of the apparatus further comprise a capability for common encoder training and a configured format for ground truth data sharing.

32. The apparatus of claim 31, wherein the instructions, when executed by the at least one processor, cause the apparatus at least to:
transmit, to the network, a ground truth input to the artificial intelligence encoder; and
based on the network training the artificial intelligence decoder using the ground truth input to the artificial intelligence encoder, receive, from the network, the training dataset comprising the following: the unquantized projected channel state information feedback, and the dequantized projected channel state information feedback.

33. The apparatus of claim 32, wherein the instructions, when executed by the at least one processor, cause the apparatus at least to:
transmit, to the network, an indication of completion of the training of the artificial intelligence encoder using the training dataset.

34. The apparatus of claim 33, wherein the channel eigenvector is a most dominant channel eigenvector of a plurality of channel eigenvectors.

35. The apparatus of claim 34, wherein the instruction, when executed by the at least one processor, are performed offline during interoperability development testing wherein runtime gradient sharing is not required.

36. A system comprising:
an apparatus:
at least one processor; and
at least one memory storing instructions that, when executed by the at least one processor, cause the apparatus at least to:
receive the following from a network: a training dataset comprising an input to a hypothetical artificial intelligence encoder, an unquantized projected channel state information feedback, and dequantized projected channel state information feedback, wherein the input to the hypothetical artificial intelligence encoder comprises: channel information, a channel matrix, a channel eigenvector, and a precoding matrix in a spatial-frequency domain, wherein the unquantized projected channel state information feedback comprises a latent vector, wherein the unquantized projected channel state information feedback has finer granularity than the dequantized projected channel state information feedback;
receive, from the network, the dequantized projected channel state information feedback within the training dataset, when a quantization and dequantization rule is not received from the network, or when a codebook and mapping scheme is not received from the network;
based on the unquantized projected channel state information feedback and the dequantized projected channel state information feedback, learn a quantizer and generate a codebook, wherein the learning of the quantizer and the generating of the codebook is performed when the unquantized projected channel state information feedback and the dequantized projected channel state information feedback are in a same dataset;
train an artificial intelligence encoder using a loss function, wherein input arguments to the loss function comprise the unquantized projected channel state information feedback from the received training dataset and unquantized channel state information feedback taken at an output of the artificial intelligence encoder; and
encode channel state information, using the trained artificial intelligence encoder.

37. The system of claim 36, wherein the instructions, when executed by the at least one processor, cause the apparatus at least to transmit, to the network, capabilities of the apparatus, wherein the capabilities of the apparatus comprise: a supported model identifier, and a capability for over-the-air dataset sharing.

38. The system of claim 37, wherein the capabilities of the apparatus further comprise a capability for common encoder training and a configured format for ground truth data sharing.

39. The system of claim 38, wherein the instructions, when executed by the at least one processor, cause the apparatus at least to:
transmit, to the network, a ground truth input to the artificial intelligence encoder; and
based on the network training the artificial intelligence decoder using the ground truth input to the artificial intelligence encoder, receive, from the network, the training dataset comprising the following: the unquantized projected channel state information feedback, and the dequantized projected channel state information feedback.

40. The system of claim 39, wherein the instructions, when executed by the at least one processor, cause the apparatus at least to:
transmit, to the network, an indication of completion of the training of the artificial intelligence encoder using the training dataset.

41. The system of claim 40, wherein the channel eigenvector is a most dominant channel eigenvector of a plurality of channel eigenvectors.

42. The system of claim 41, wherein the instruction, when executed by the at least one processor, are performed offline during interoperability development testing wherein runtime gradient sharing is not required.

43. A method comprising:
receiving, by an apparatus, the following from a network: a training dataset comprising an input to a hypothetical artificial intelligence encoder, an unquantized projected channel state information feedback, and dequantized projected channel state information feedback, wherein the input to the hypothetical artificial intelligence encoder comprises: channel information, a channel matrix, a channel eigenvector, and a precoding matrix in a spatial-frequency domain, wherein the unquantized projected channel state information feedback comprises a latent vector, wherein the unquantized projected channel state information feedback has finer granularity than the dequantized projected channel state information feedback;
receiving, from the network, the dequantized projected channel state information feedback within the training dataset, when a quantization and dequantization rule is not received from the network, or when a codebook and mapping scheme is not received from the network;
based on the unquantized projected channel state information feedback and the dequantized projected channel state information feedback, learning a quantizer and generating a codebook, wherein the learning of the quantizer and the generating of the codebook is performed when the unquantized projected channel state information feedback and the dequantized projected channel state information feedback are in a same dataset;
training an artificial intelligence encoder using a loss function, wherein input arguments to the loss function comprise the unquantized projected channel state information feedback from the received training dataset and unquantized channel state information feedback taken at an output of the artificial intelligence encoder; and
encoding channel state information, using the trained artificial intelligence encoder.

44. The method of claim 43, further comprising transmitting, to the network, capabilities of the apparatus, wherein the capabilities of the apparatus comprise: a supported model identifier, and a capability for over-the-air dataset sharing.

45. The method of claim 44, wherein the capabilities of the apparatus further comprise a capability for common encoder training and a configured format for ground truth data sharing.

46. The method of claim 45, further comprising:
transmitting, to the network, a ground truth input to the artificial intelligence encoder; and
based on the network training the artificial intelligence decoder using the ground truth input to the artificial intelligence encoder, receiving, from the network, the training dataset comprising the following: the unquantized projected channel state information feedback, and the dequantized projected channel state information feedback.

47. The method of claim 46, further comprising transmitting, to the network, an indication of completion of the training of the artificial intelligence encoder using the training dataset.

48. The method of claim 47, wherein the channel eigenvector is a most dominant channel eigenvector of a plurality of channel eigenvectors, and wherein the method is performed offline during interoperability development testing wherein runtime gradient sharing is not required.
